(19) United States
(12) Patent Application Publication
(10) Pub. No.: US 2024/0405388 A1
(43) Pub. Date: Dec. 5, 2024

(54) TERMINAL RIVET FOR A SECONDARY CELL

(71) Applicant: NORTHVOLT AB, Stockholm (SE)

(72) Inventors: Michael SHAUGHNESSY, Västerås (SE); Dennis BEIN, Västerås (SE)

(21) Appl. No.: 18/733,246

(22) Filed: Jun. 4, 2024

(30) Foreign Application Priority Data
Jun. 5, 2023 (SE) 2350687-6

(51) Int. Cl. H01M 50/566; H01M 10/04; H01M 10/0587; H01M 50/107; H01M 50/152; H01M 50/533

(52) U.S. Cl. CPC H01M 50/566; H01M 10/0431; H01M 10/0587; H01M 50/107; H01M 50/152; H01M 50/533

(57) ABSTRACT

There is disclosed herein a terminal rivet (100), a cylindrical secondary cell (6000) comprising such a terminal rivet (100), and a method (1000) of manufacturing such a secondary cell (6000). The rivet (100) comprises a shaft (110) configured to extend axially (A) through a casing of the secondary cell to thereby electrically contact a current collecting plate of the secondary cell at a first end (110a) of the shaft (110) and a head (120) arranged at a second end (110b) of the shaft (110), configured to form an external terminal for the cylindrical secondary cell. The head (120) comprises a central region (122) and a first welding region (124) arranged around said central region (122), wherein the first welding region (124) is recessed relative to said central region (122). The first end (110a) of the shaft (110) comprises a second welding region (114), aligned along the axis (A) of the shaft with the first welding region (124), and recessed towards the first welding region (124).

### CROSS-REFERENCE TO RELATED APPLICATIONS

The present disclosure claims priority to and the benefit of Swedish Patent Application Serial No. 2350687-6, filed Jun. 5, 2023, the contents of which as are hereby incorporated by reference herein in their entirety.

### BACKGROUND

### Related Field

The present disclosure relates to a terminal rivet for a secondary cell, a secondary cell comprising the terminal rivet, and a method of manufacturing such a secondary cell.

### Related Art

In addressing climate change, there is an increasing demand for rechargeable batteries, e.g. to enable electrification of transportation and to supplement renewable energy. Currently, lithium-ion batteries are becoming increasingly popular. They represent a type of rechargeable battery in which lithium ions move from the negative electrode to the positive electrode during discharge and back when charging.

As the demand for rechargeable batteries increases, more and more focus is being placed on production speed and cost. To achieve an effective production of rechargeable batteries, the design of the batteries as well as their manufacturing process can be optimized.

### SUMMARY

The present disclosure aims to provide improved secondary cells and parts thereof. The improvements may be in energy performance, manufacturing efficiency, and assembly simplification, among others.

In particular, according to an aspect of the present disclosure, there is provided a terminal rivet for a cylindrical secondary cell, comprising a shaft configured to extend axially through a casing of the secondary cell to thereby electrically contact a current collecting plate of the secondary cell at a first end of the shaft, and a head arranged at a second end of the shaft, configured to form an external terminal for the cylindrical secondary cell.

The overall shape of the cylindrical secondary cell may be substantially determined by its cylindrical casing, extending between two substantially flat ends. According to an embodiment of the present disclosure, a first end of the cylindrical casing comprises an opening for receiving a rivet. The opening may be shaped and sized to correspond to a shape and size of the shaft of the rivet, allowing as well for the addition of a gasket around said shaft. The head of the rivet may then extend like a flange from the second end of the shaft, such that the head is larger than the opening in the casing.

In an example embodiment, the shaft is cylindrical and configured to extend axially through a circular opening in the casing of the cylindrical secondary cell. In this embodiment, the head is substantially disc shaped, and configured to close the circular opening in the casing of the cylindrical secondary cell by being sized larger than the opening.

Hence, when the shaft of the rivet is introduced into the opening of the casing, having a gasket therearound and a part of the gasket extending between the head and the casing of the cell, the opening in the casing may be sealed in a substantially fluid-tight manner. The first end of the shaft is then riveted and thereby deformed to retain the rivet in place in the opening of the casing, in a manner understood by those skilled in the art.

The part of the gasket around the shaft thus forms a fluid seal for the opening in the casing to retain liquid electrolyte within the cell. At least this part of the gasket may thus be preferably configured for mechanical resilience and resistance against corrosion.

The part of the gasket between the head of the rivet and the end of the casing around the opening electrically insulates the head of the rivet from the casing. At least this part of the gasket may thus be preferably configured for electrical insulation. Both parts of the gasket (which may be monolithically formed) may be preferably configured to withstand the highest temperatures expected to be incident thereupon during manufacture and operation of the cell.

The head of the terminal rivet can thus act as an external terminal for the cell by being electrically conductive (e.g., formed from a metal such as aluminum or an alloy thereof) and electrically connected, via the first end of the shaft, to a current collecting disc. The current collecting disc (e.g., a cathode disc formed of aluminum or an alloy thereof) may then be arranged in direct electrical contact with the exposed tabs of the electrode roll of the cell (e.g., cathode tabs), at a first end of the electrode roll.

When manufacturing the cell, the terminal rivet may be welded to the current collecting disc to thereby form a reliable electrical and mechanical connection therebetween. Such welding (or soldering) may be performed by any suitable means such as a welding laser, ultrasonic welding, capacitor discharge welding, or the like. In preferred examples, the welding means is directed from an outside of the cell, i.e., directed at the head of the terminal rivet. Thereby, a manufacture of the secondary cell is greatly simplified and ejecta resulting from such welding are advantageously kept from contaminating an internal of the cell.

At the other end of the electrode roll, further exposed tabs may extend therefrom (e.g., anode tabs) and may be electrically connected (directly or via a further current collecting disc) to the casing of the cell, which may be formed of metal such as nickel-plated steel or aluminum. Accordingly, the entire surface of the casing, including the end of the casing having the opening closed by the terminal rivet, may act as one electrode of the battery, and the head of the terminal rivet may act as another (opposite) electrode of the battery. Hence, both terminals of the cell may advantageously be available for connecting to (e.g., via busbars in a battery module) at the same end of the cylindrical secondary cell. The head of the terminal rivet may act as a positive (cathode) terminal for the cell and the exposed surface of the casing surrounding the terminal rivet may act as a negative (anode) terminal for the cell.

That is, in an example implementation of a cylindrical secondary cell, the first end of the casing comprises a first electrical contact surface extending in a first plane, and the head of the terminal rivet comprises a second electrical contact surface, extending in a second plane axially spaced from the first plane, i.e., away from the casing.

When installing such cells into a battery module, busbars or other connectors may be welded or otherwise connected along the terminals of the cells to thereby electrically interconnect the cells within the battery module. According to aspects of the present disclosure, an enhanced attachment surface on the head terminal rivet is provided for attaching to such busbars or other connectors, and an case of welding the terminal rivet to the current collecting plate is greatly enhanced.

In particular, according to aspects of the present disclosure, the head comprises a central region and a first welding region arranged around said central region, wherein the first welding region is recessed relative to said central region.

The central region may at least overlap a geometric centre of the head of the terminal rivet (when viewed along the axis of extension of the shaft). The central region may be configured to form an extreme end of the cell so as to reliably and easily have a busbar of a module connected thereto. The central region may thus be preferably be shaped and sized to correspond to an expected dimension of such a busbar. By ensuring that the central region at least overlaps a geometric centre of the head of the terminal rivet, it can be ensured that, no matter the rotational orientation of the cylindrical cell, the location of the connection point for a busbar is not substantially displaced from an expected location. The central region may be formed to be substantially flat, and may have a smooth or patterned surface, depending of the implementation.

The first welding region is recessed relative to the central region such that no part of the first welding region extends above the central region. In some examples, the first welding region is formed entirely within the head of the rivet, while in some other examples, the first welding region may be recessed from the head and into part of the shaft of the terminal rivet.

The first welding region may be formed as a recess having a flat, curved, tapered, or other profile, depending on the implementation. In a particular example, the entire central region may lie along a first plane and the entire first welding region may lie along a second plane spaced apart from the first plane, towards the first end of the shaft of the terminal rivet.

According to this aspect of the present disclosure, the first end of the shaft comprises a second welding region, aligned (at least partially) along the axis of the shaft with the first welding region, and recessed towards the first welding region. Put another way, when viewed along the axis of the shaft of the rivet, the first and second welding regions are at least partially overlapping, such that an improved thermal path along the axis of the rivet is provided between the first welding region and the second welding region.

By providing a central region in the head of the terminal rivet that is not recessed, a greater mass of material is provided in the terminal rivet for dissipating heat and for improving the electrical conductivity of the terminal rivet, especially along the central axis thereof. Greater heat dissipation may thus mitigate or prevent damage to the gasket around the terminal rivet which, if damaged, could cause the cell to be improperly sealed. Moreover, if heat is better dissipated throughout the terminal rivet, damage to the electrode roll can also be mitigated or prevented. The heat to be dissipated may arise from a welding process and/or from Ohmic heating during charging or discharging of the cell.

The central region, the first welding region, and the second welding region may define substantially planar surfaces. It will be appreciated that, as a result, a solid material mass is provided between the central region of the head and a central region of the first side of the shaft. For example, a substantially cylindrical solid mass may be defined between the central region of the head and a corresponding central region on the first side of the shaft. This solid mass, being central and hence away from the sealing gasket around the rivet, may advantageously dissipate particularly Ohmic heating generated during charge/discharge of the cell, or heating from welding.

According to some examples, the first end of the shaft comprises a central region and the second welding region is arranged around said central region of the first end of the shaft. According to other examples, second welding region includes the central region of the first end of the shaft. If the first end of the shaft is provided with a central region that is not recessed, then a yet greater mass of material may be provided along the central axis of the rivet, thereby further enhancing the thermal and electrical properties of the terminal rivet as discussed above.

The first welding region and the second welding region may be substantially identical and thereby entirely overlap one another when viewed axially. That is, according to some examples, the second welding region corresponds in its shape to the first welding region. Therefore, it may be that the terminal rivet is formed with a maximal amount of material while facilitating the formation of an effective welding path between the first and second welding regions. Viewed from another perspective, it can be said that, according to such examples, a recessed region is provided on the first end of shaft of the terminal rivet if and only if an axially corresponding recess is formed on the head of the terminal rivet.

In some examples, the first welding region is a continuous region surrounding the central region. That is, the central region may be entirely surrounded by the first welding region. In a particular example, the central region is circular and the first welding region is annular and concentric with the central region. In other examples, the first welding region may only partially surround the central region in one or more discrete sections.

The first welding region may, in some examples, extend radially to a radial extreme of the head of the terminal rivet. That is, it may be that the head of the terminal rivet substantially consists of the central region and the first welding region. In other examples, the head further comprises a peripheral region arranged around the first welding region, where the first welding region is recessed relative to said peripheral region. The peripheral region may be flush with the central region, recessed relative to the central region or may even protrude beyond the central region, depending on the particular implementation.

The first end of the shaft may further comprise a riveting region arranged around the second welding region, configured to deform under riveting of the terminal rivet. Preferably, the riveting region and the deformation thereof does not interfere with or obstruct the second welding region such that, after riveting, a suitable surface is provided in said riveting region for contacting or avoiding the current collecting plate. In the riveted state, the riveting region or a part thereof may extend radially beyond the opening in the end of the casing such that the terminal rivet is held in place in said opening.

According to a further aspect of the present disclosure, there is provided a cylindrical secondary cell comprising an electrode roll housed in a cylindrical casing and a terminal rivet substantially as described above, arranged at a first end of the cylindrical casing. The cylindrical secondary cell further comprises a current collecting plate in direct electrical contact with the electrode roll, wherein the first end of the shaft of the terminal rivet is in direct electrical contact with the current collecting plate.

According to some example embodiments of such a cylindrical secondary cell, the current collecting plate has a first side for direct electrical contact with the terminal rivet, and a second side for direct electrical contact with the electrode roll, and the first side of the current collecting plate comprises a protrusion configured to extend into the recessed second welding region on the first end of the shaft of the terminal rivet.

According to some examples, the protrusion on the first side of the current collecting plate is configured to contact the terminal rivet at least at the second welding region. Thereby, welding energy (e.g., thermal or heat energy) can be readily communicated from the first welding region and through the terminal rivet to the second welding region, at which point the part of the protrusion of the current collecting plate that is contacting the second welding region can be welded to the terminal rivet at said contact point.

In a preferred example, the protrusion is configured to complement and correspond to the second welding region, so as to advantageously enhance the contacting surface area between the terminal rivet and the current collecting plate. Hence, the electrical and mechanical connection between the terminal rivet and the current collecting plate can be greatly enhanced.

A larger protrusion on the current collecting disc may be advantageously easier to manufacture, and may better distribute heat, e.g., welding heat or Ohmic heat (generated during operation of the cell). Thus, damage to the electrode roll during welding may be mitigated or prevented.

The protrusion on the current collecting disc may be shaped in any suitable way. In some examples, the protrusion may be tapered or chamfered so as to engage with a corresponding tapering or chamfering in the second welding region, thereby assisting with a centering of the current collecting disc relative to the terminal rivet. Hence, the alignment of the current collecting disc and the terminal rivet prior to welding can be advantageously enhanced. The protrusion may further advantageously be rotationally symmetric so as to enable engagement between the current collecting disc and the terminal rivet at any relative rotational orientation.

In some examples, the second side of the current collecting plate comprises a recess. The recess may match the protrusion on the first side of the current collecting disc and may be formed through, e.g., stamping of the current collecting disc. In some examples, the recess may be configured to receive or enable alignment with a center pin of the cylindrical secondary cell.

In some cases, as also discussed above, the first welding region may undesirably interrupt an electrical contact surface for the external terminal of the cell. In such cases, the connection surface for busbars or other connectors may be enhanced through the provision of a cap or filling of the terminal rivet, at least covering the first welding region. Hence, in example implementations wherein a cap is to be applied, the first welding region is configured to receive the cap. Such a configuration may comprise applying a threading or other engaging profiling to a recess of the first welding region.

Instead of a cap, the first welding region may instead be at least partially filled with a filling, such as a paste or a putty, which may harden or set after application. The filling may be electrically conductive and thereby provide similar advantages to those associated with the provision of a cap. Additionally or alternatively, the filling may be a protective material such as a resin or glue configured to prevent rusting or corrosion, which may be more likely in the first welding region due to damage from application of the welding means.

According to yet a further aspect of the present disclosure, there is provided a method of manufacturing a cylindrical secondary cell such as one substantially as described above. The method comprises arranging the terminal rivet and the current collecting plate such that the first end of the shaft of the terminal rivet abuts the current collecting plate, and directing a welding means at the first welding region to thereby weld the terminal rivet to the current collecting plate.

The welding means may be a welding laser, soldering iron, ultrasonic welding, capacitor discharge welding, or any other suitable welding means whose welding energy may be more effectively communicated through the shorter material path formed between the recessed first and second welding regions.

Prior to the arrangement of the current collecting plate in abutment with the first end of the shaft of the terminal rivet, the shaft of the terminal rivet may be arranged through an opening in a first end of the casing and riveted to thereby secure the terminal rivet in place at the first end of the casing.

Prior to said riveting, the terminal rivet may have a gasket arranged therearound, which serves a first purpose to create a fluid-tight seal between the terminal rivet and the opening in the first end of the casing, and a second purpose to form an electrically insulating layer between the terminal rivet and the casing. The gasket may preferably extend substantially radially beyond the head of the terminal rivet to reliably insulate the head of the terminal rivet, acting as one terminal of the cell, from the casing, acting as the other terminal of the cell.

Further prior to the arrangement of the current collecting plate in abutment with the first end of the shaft of the terminal rivet, the current collecting plate may have been already arranged in direct electrical contact with the electrode roll of the cell, for example being welded thereto. The electrode roll may comprise respective pluralities of notched tabs extending from its ends, wherein a first plurality of notched tabs are extensions of or attachments to the cathode electrode sheet, and a second plurality of notched tabs at the opposite end are extensions of or attachments to the anode electrode sheet. The tabs may be folded over to form a connective surface for welding or otherwise attaching a current collecting plate to.

Hence, in an assembled form of the cylindrical secondary cell, electrical energy stored in the electrode roll may be collected by the current collecting plate and provided, via an electrically conductive connection therebetween, to the terminal rivet.

The terminal rivet is preferably be welded to the current collecting plate by application of a welding means from outside the casing. That is, a welding means such as a welding laser may be directed at the first welding region on the head of the terminal rivet, and the thermal path formed between the first welding region and the second welding region transfers the welding energy to the contact point between the terminal rivet and the current collecting plate, such that they are welded together. Accordingly, the case of manufacture of the cylindrical secondary cell is enhanced as it is not required to direct or maneuver the welding means internally within the casing of the cell. Moreover, the risk of ejecta from the welding process contaminating an internal of the cell is advantageously reduced.

Accordingly, aspects of the present disclosure provide improvements in energy performance, manufacturing efficiency, and assembly simplification, for terminal rivets and the cylindrical secondary cells in which they are installed, among other advantages which will be made clear through the below description of specific embodiments.

### BRIEF DESCRIPTION OF THE DRAWINGS

One or more embodiments of the present disclosure will be described, by way of example only, and with reference to the following figures, in which:

FIGS. 1A, 1B, and 1C schematically show a side cross-sectional view, a top view, and a bottom view of a terminal rivet according to aspects of the present disclosure;

FIG. 2 schematically shows a side cross-sectional view of a terminal rivet having an alternative second welding region;

FIGS. 3A and 3B schematically show alternative examples for the first welding region;

FIGS. 4A and 4B schematically show a terminal rivet according to aspects of the present disclosure, with examples of having a cap received in the first welding region;

FIGS. 5A and 5B schematically show a terminal rivet according to aspects of the present disclosure, before and after a riveting process;

FIG. 6 schematically shows a cross-sectional side view of a cylindrical secondary cell according to aspects of the present disclosure;

FIGS. 7A and 7B schematically show a mating between a center pin, a current collecting disc, and a terminal rivet, according to aspects of the present disclosure;

FIGS. 8A and 8B schematically illustrate a protrusion on a current collecting disc extending into the second welding region of a terminal rivet, according to aspects of the present disclosure;

FIGS. 9A, 9B, and 9C schematically show an arrangement and welding of a terminal rivet, current collecting disc, and option cap, according to aspects of the present disclosure; and

FIG. 10 illustrates a method of manufacturing a cylindrical secondary cell, according to aspects of the present disclosure.

### DETAILED DESCRIPTION

The present disclosure is described in the following by way of a number of illustrative examples. It will be appreciated that these examples are provided for illustration and explanation only and are not intended to be limiting on the scope of the present disclosure. Instead, the scope of the present disclosure is defined by the appended claims.

Furthermore, although embodiments be presented individually for the sake of focused discussion of particular features, it will be recognized that the present disclosure also encompasses combinations of the embodiments described herein.

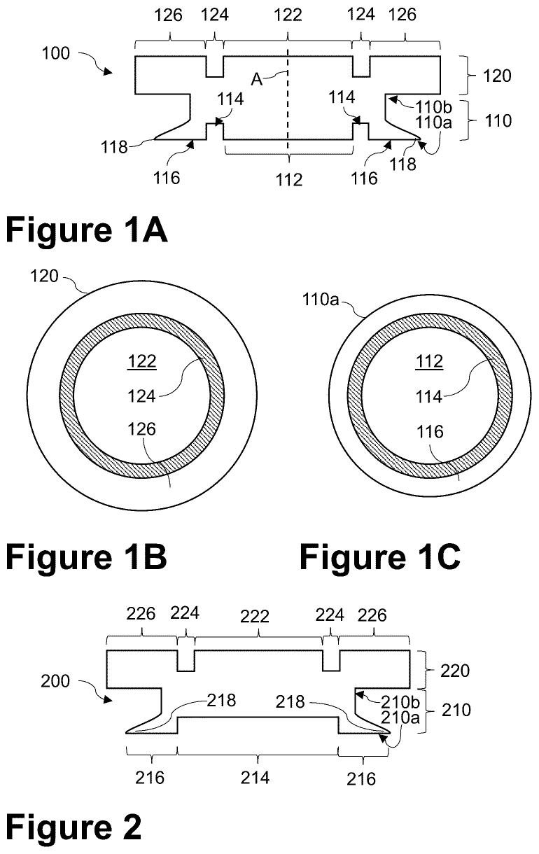

FIGS. 1A, 1B, and 1C schematically show a side cross-sectional view, a top view, and a bottom view of a terminal rivet 100, according to aspects of the present disclosure.

As shown in FIGS. 1A-C, the terminal rivet 100 (also referred to herein as simply ‘rivet 100’) comprises a shaft 110 and a head 120. The shaft 110 extends along an axis A from a first end 110a to a second end 110b, wherein the first end 110a is for arranging against a current collecting plate (not shown) and the head 120 is arranged at the second end 110b of the shaft. In this illustrated example, the shaft 110 is formed substantially as a cylinder and the head 120 is formed as a disc (i.e., as a cylinder having a greater radius than the shaft 110) and the substantially circular profiles of the shaft 110 and head 120 are concentric around the axis A.

The head 120 (i.e., the top surface thereof that is to form an external terminal for a cell) comprises a central region 122 and a first welding region 124 arranged around said central region, shown more clearly in FIG. 1B. The central region 122 is circular and centered on the circular head 120, and the first welding region 124 is annular and concentric with the central region 122. The first welding region 124 is shown as having a constant width and a flat recess profile (i.e., the bottom surface of the recess of the first welding region 124 is flat), however in other examples, the width of the first welding region 124 and the profile of the recess may be variable.

The head 120 further comprises a peripheral region 126 that is flush with the central region 122, i.e., in the same plane as the central region 122. The peripheral region 126 is also annular arranged around the first welding region 124, concentric with the first welding region 124 and the central region 122. In other examples, the peripheral region 126 may be recessed or protruding relative to the central region 122, or may be shaped differently.

The first end 110a of the shaft 110 comprises a central region 112 and a second welding region 114. In this illustrated example, it can be seen that the central region 112 of the first end 110a of the shaft is aligned along the axis A (i.e., along a line that is at least parallel thereto) with the central region 122 of the head of the rivet 100, and that the central region 112 of the first end 110a of the shaft 110 has the same shape, i.e., circular with the same radius, as the central region 122 of the head 120. Similarly, the second welding region 124 is aligned along the axis A with the first welding region 124, and corresponds in its shape thereto, at least when viewed along the axis A, i.e., taking the views from FIGS. 1B and 1C.

It can be seen that, were the views of FIGS. 1B and 1C to be superimposed with one another, the first welding region 124 and the second welding region 114 would substantially overlap with one another. Thereby, it can be understood that the second welding region 124 is at least partially axially aligned with the first welding region 114.

It will be appreciated that the solid illustration of the rivet 100 may indicate that the rivet 100 is substantially monolithic in formation, and has no cavities, through-holes, openings, or the like within its structure, that might comprise the thermal and electrical properties of the rivet 100.

It can then be appreciated from FIG. 1A that, as a result of this alignment, a shorter material path is formed between the first welding region 124 and the second welding region 114. Hence, if a welding means such as a welding laser is incident upon the first welding region 124, the welding energy can be readily transmitted from the first welding region 124 to the second welding region 114. The greater mass of material provided between the non-recessed central region 122 of the head 120 and the central region 112 of the first end 110a of the shaft 110 (i.e., defining a solid cylindrical mass therebetween) advantageously serves to dissipate heat from a welding means (or from Ohmic heating) and thus prevents damage to, e.g., a gasket (not shown) arranged against the rivet 100, and/or an electrode roll (not shown) of the cell.

The first end 110a of the shaft 110 further comprises a riveting portion 118 formed as a result of the riveting of the rivet 100, which is discussed in more detail in connection with FIGS. 5A and 5B.

FIG. 2 schematically shows a side cross-sectional view of a terminal rivet 200 having an alternative second welding region 214, wherein reference numerals having the same latter two digits as reference numerals for components in FIGS. 1A-C are attached to components that are the same or similar at least in function to those components shown in these FIGS. 1A-C. The same applies for the discussion of figures throughout this description, and thus like-numbered components in later figures may not be discussed in detail again.

The rivet 200 shown in FIG. 2 has a second welding region 214 that includes the central region of the first end 210a of the shaft 210. That is, the second welding region 214 is formed as a circle. It can be seen that the second welding region 214 is still axially aligned with the first welding 214 at least partially, such that there exists an advantageously shorter material path for transferring a welding energy through the rivet 200 between the first welding region 224 and the second welding region 214, while retaining a non-recessed central portion 222 on the head 220 of the rivet 200 for connection to busbars or the like.

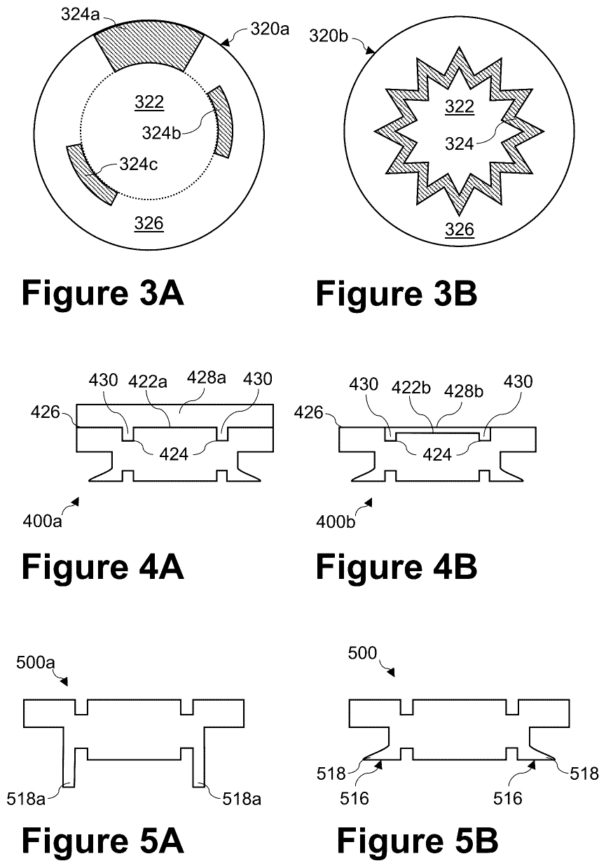

FIGS. 3A and 3B schematically show the head 320a, 320b of a rivet according to aspects of the present disclosure, with alternative examples for the first welding region 324.

As illustrated in FIG. 3A, the first welding region 324 may only partially surround the central region 322, being formed as three separate regions 324a, 324b, 324c, while in other examples there fewer or more regions. As illustrated in region 324a, the first welding region may extend all the way to the outer radial edge of the head 320a of the rivet. Moreover, although the regions 324a, 324b, 324c, are shown arranged irregularly around the central region 322, in other examples, the first welding region 324 may be formed as a plurality of discrete regions arranged regularly around the central region 322, depending on the implementation.

As shown in FIG. 3B, the first welding region 324 may take any shape, such as a polygon, line segment, or, as illustrated, a star-shape. In this example, the first welding region 324 again has a constant width, but in other examples, the width may vary.

Depending on the means by which a welding means is applied, a circular or partially circular shape for the first welding region 324 may be preferred, such that simple rotational motions can move the welding means throughout the first welding region 324. Alternatively, a straight first welding region 324 may be preferred, such that simple translational motions can move the welding means throughout the first welding region 324.

Turning to a discussion of FIGS. 4A and 4B, it may be that the incidence of a welding means on the first welding region 424 may risk the material therein being damaged such that it is more susceptible to corrosion, rust, or may have an unfavorable surface profile. Accordingly, and as illustrated in these figures, a cap 428a, 428b can be applied to at least the first welding region 424.

The first welding region 424 may be configured in some way to receive the cap 428a, 428b, such as by threading or otherwise profiling the first welding region 424 so as to mate with or engage with protrusions 430 on the cap 428a, 428b. The cap 428a, 428b may be configured to form part of an external terminal for the cell, e.g., by having a flat top surface for connecting (e.g., welding) to busbars or other connectors.

The cap 428a shown in FIG. 4A is dimensioned so as to extend across the central region 422a, the first welding region 424, and the peripheral region 426, while the cap 428b shown in FIG. 4B is dimensioned so as to only extend across the central region 422b and the first welding region 422b. In order to ensure that the top of the cap 428b is flush with the peripheral region 426 of the head 420 of the rivet 400b, the peripheral region 426 protrudes relative to the central region 422b.

The addition of the cap 428a, 428b thereby provides advantages of a protected first welding region 424 after a welding means has been applied thereto, and an enhanced surface for forming an external terminal of the cell.

FIGS. 5A and 5B schematically show a terminal rivet 500a, 500b according to aspects of the present disclosure, before (500a) and after (500b) a riveting process.

The rivet 500a may formed by, for example, cold pressing, additive or subtractive manufacturing, or other techniques, depending on the material from which the rivet 500a is formed (such as aluminum or an alloy thereof). In its pre-riveted state, the rivet 500a comprises a portion 518 intended to be deformed during a rivet process and thereby expanded radially outwards—as shown in FIG. 5B—so as to cause the rivet 500b to be held in place in the casing of the cell.

The particulars of the riveting process are not discussed at length but a number of techniques for riveting rivets 500a, such as those described herein, are well understood by those skilled in the art.

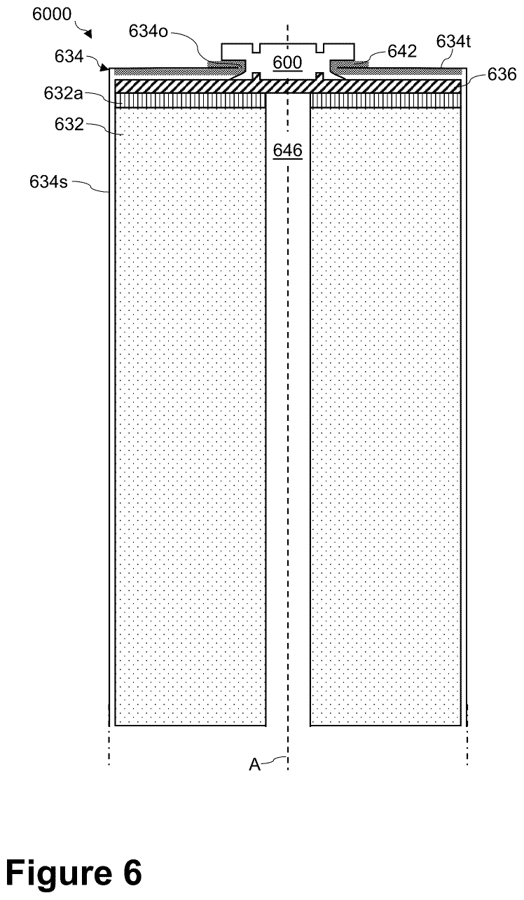

FIG. 6 schematically shows a cross-sectional view of a cylindrical secondary cell 6000 comprising a rivet 600 extending through an opening 6340 in the casing 634, corresponding to the example rivet 100 shown and discussed in relation to FIGS. 1A-C. The particulars of the rivet 600 are thus not discussed again in relation to FIG. 6.

The cylindrical secondary cell 6000 (also referred to as simply the ‘cell 6000’) comprises an electrode roll 632 housed in a cylindrical casing 634. The electrode roll 632 may be formed of an anode sheet, a cathode sheet, and a separator sheet arranged therebetween to thereby enable a storage of electrical energy. Cathode tabs 632a may extend from a first end of the electrode roll 632 and anode tabs (not shown) may extend from the other end, or vice versa. The cathode tabs 632a and anode tabs may provide connective surfaces to which current collecting plates (e.g., plate 636) can be connected.

The cylindrical casing 634 extends along an axis A between a first end 643t, which may be referred to as a ‘top end 634t’, and an open bottom end (not shown) which is closed by a lid. The closure of the casing may comprise a clamped closure or a welded closure, depending on the implementation.

For example, the casing 634 may further comprise a beading groove (not shown) formed in the side wall 634s. Hence, between the beading groove and the end edge of the side wall towards the bottom end of the casing, a clamping portion can be formed. A lid gasket may then be clamped around the bottom lid in the clamping portion to thereby seal the open bottom end of the casing. Providing a clamped closure in this way is well known in the art and can provide a reliable waterproof seal for the cell.

As another example, the lid may be welded to the casing to thereby seal the casing. The lid may be additionally welded to a current collector, or the lid may act as a current collector itself and be attached (e.g., welded) to the tabs of the electrode roll 632. Providing a welded closure in this way may advantageously remove the number of components of the cell and/or the number of process steps required to manufacture the cell.

A cathode current collecting plate 636 is arranged in direct electrical contact with the cathode tabs 632a and an anode current collecting plate (not shown) is arranged in direct electrical contact with the anode tabs (also not shown). Here, the labels ‘cathode’ and ‘anode’ may be swapped. Thus, an electrical connection is formed from the cathode tabs 632a to the rivet 600, as the rivet 600 is connected to the current collecting plate 636.

An electrical connection may also be formed from the anode tabs to the casing 634, either directly or through connection of an anode current collecting plate to the casing 634, e.g., in the clamping portion or by welding. One or both of the current collectors may be formed as a disc, a plate, or have some other shape.

At either end of the cell, the cell may further comprise a vent for venting gases, for example during a failure of the cell. Moreover, the cell may comprise an additional through-hole, in the casing and/or in the lid, for filling the cell with a liquid electrolyte. This through-hole is preferably adapted to be closed from the outside, such as through the use of a blind rivet.

Thus, it is seen that the exposed head of the terminal rivet 600 serves as an external terminal of the cell 6000, this being a positive terminal in this example, and the casing 634 serves as the negative terminal. Hence, it is seen that both terminals of the cell 6000 are accessible at the same side. The top end 634t of the casing 634 comprises a first electrical contact surface extending in a first plane, and the head of the rivet 600 comprises a second electrical contact surface, extending in a second plane axially spaced from the first plane.

Arranged around the terminal rivet 600 is a gasket 642 configured to form a fluid-tight seal for the opening 6340 in the top end 634t of the casing 634. The gasket 642 is arranged at least around the shaft of the rivet 600. The gasket 642 further extends between the head of the rivet 600 and the top end 634t of the casing 634 so as to electrically isolate the opposite terminals of the cell 6000 from each other. Thus, it can be seen that gasket 642 serves multiple purposes. The gasket 642 may be preferably formed of a polymer having elastic, resilient, and electrically insulating properties, such as PFA. In preferred examples, including that illustrated in FIG. 6, the gasket 642 extends between the head of the rivet 600 and the casing 634, radially beyond the head of the rivet 600.

In some examples, the gasket 642 may be formed of separate parts, each part being specifically configured for a respective purpose. For example, for the part(s) of the gasket 642 around the opening 6340 and intended to seal the opening, the gasket 642 may be formed of one material such as PFA. For the part(s) of the gasket 642 between the head of the rivet 600 and the casing 634 and intended to electrically isolate these components from each other, the gasket 642 may be formed from another material such as a PPS polymer.

As discussed above, the advantageous configuration of the non-recessed central region of the rivet 600, provided a greater material mass to the rivet 600, aids in dissipate heat throughout the rivet 600, e.g., from welding or Ohmic heating. Hence, there is a reduced risk that the gasket 642 and/or the cathode tabs 632a are damaged by an excessively heated rivet 600.

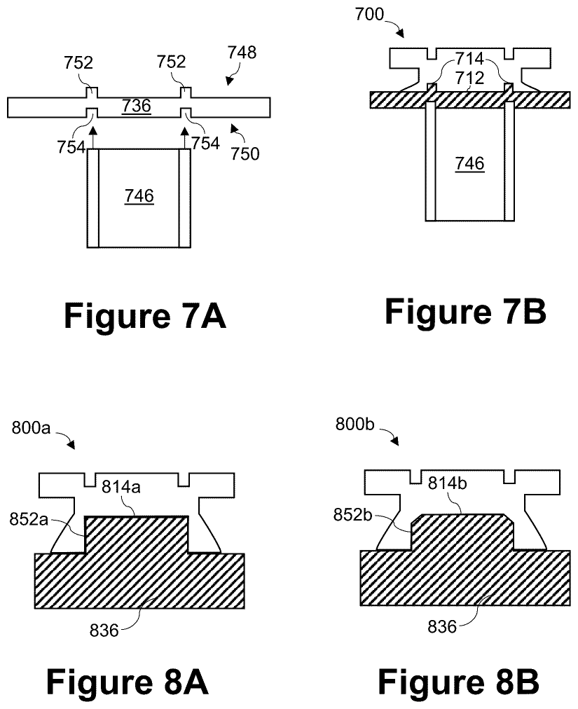

The electrode roll 632 is arranged around a center pin 646, although in other examples, this may be an empty space or cavity. As shown in more detail in FIGS. 7A and 7B, the current collecting plate 736 comprises a recess configured to be engaged by the center pin 746 to thereby aid in positioning or centering the current collecting plate 736 on the center pin 746.

On a first side 748 of the current collecting plate 736, there are protrusions 752 (or a protrusion 752 if connected outside of the plane of the cross-section shown) for extending into the second welding region 714 of the rivet 700. Positioning of the rivet 700 relative to the current collecting plate 736 may then be simplified through the provision of the protrusions 752, similarly as with the recesses 754 on the second side 750 of the current collecting plate 736, which may match the protrusions 752, as they do in the illustrated example.

Further examples of protrusions 852a, 852b from a current collecting plate 836 arc shown in FIGS. 8A and 8B, wherein the protrusions 852a, 852b are configured to match a shape of the second welding region 814a, 814b on the first end of the rivets 800a, 800b.

By matching the shape, a greater contact surface area is provided between the rivet 800a, 800b and the current collecting plate 836, such that a better welding connection can be obtained. Moreover, if the protrusion 852a, 852b provides an increased material mass, then heat dissipation can be enhanced in the same way as discussed above in respect of the benefits of the increased material mass of the rivet 800a, 800b.

The protrusion 852a shown in FIG. 8A is a simple circular protrusion configured to match the cylindrical recess of the second welding region 814a, while the protrusion 852b shown in FIG. 8B has a chamfered corner to match with a similarly chamfered corner of the second welding region 814b to thereby further enhance a contacting surface area between the rivet 800b and the current collecting plate 836.

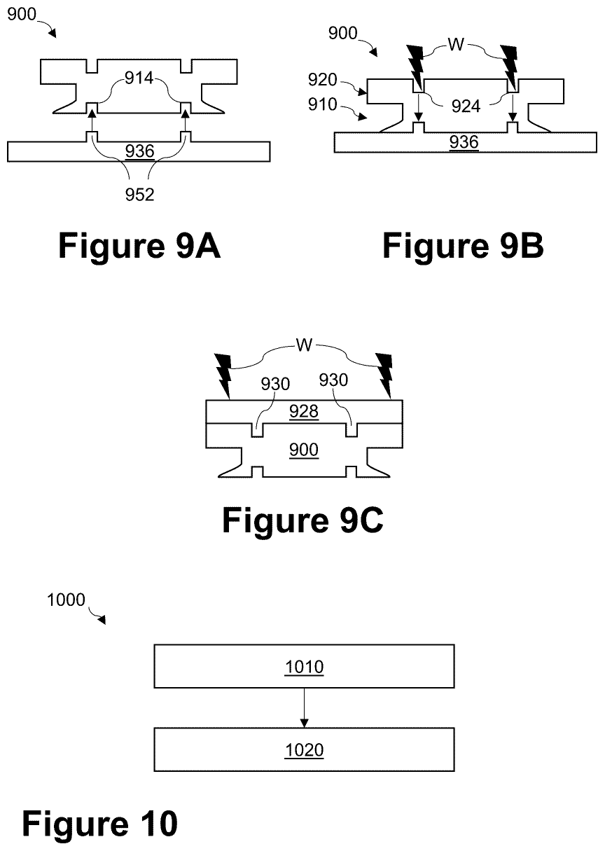

FIGS. 9A-C schematically show an arrangement and welding of a terminal rivet 900, current collecting disc 936, and optional cap 928, according to aspects of the present disclosure. FIG. 10 illustrates a method of manufacturing (a part of) a cylindrical secondary cell, according to aspects of the present disclosure, specifically the manufacturing steps illustrated in FIGS. 9A and 9B.

As shown in FIG. 9A, the method 1000 comprises arranging 1010 the terminal rivet 900 and the current collecting plate 936 such that the first end of the shaft 910 of the terminal rivet 900 abuts the current collecting plate 936. In the illustrated example, arranging 1010 the terminal rivet 900 and the current collecting plate 936 comprises aligning a protrusion 952 on the current collecting plate 936 with the second welding region of the shaft 910 of the terminal rivet 900.

As shown in FIG. 9B, the method 1000 further comprises directing a welding means W at the first welding region 924 to thereby weld the terminal rivet 900 to the current collecting plate 936. In the illustrated example, arrows are drawn to illustrate the path through the material of the rivet 900 along which the welding energy from the welding means W travels, i.e., from the first welding region 924 to the second welding region 914. The welding means W may be directed at the entirety of the first welding region 924 at the same time, or it may be traced therearound.

According to an optional embodiment, a further step of welding a cap 928 to the rivet 900 is shown in FIG. 9C. The cap 928 comprises protrusions 930 configured to be received in the first welding region 924. The cap 928 is then welded using a welding means W, which may be the same or different to that used to weld the rivet 900 to the current collecting plate 936. The welding of the cap 928 top the rivet may be at a more outward radius on the rivet 900 than the first welding region 924, as shown in FIG. 9C.

The welding means W is advantageously applied from an outside of the casing during assembly of the cell, thereby simplifying the manufacture thereof. The remaining steps for manufacturing the cell are not discussed in detail herein, but are well understood by those skilled in the art.

While the present disclosure is susceptible to various modifications and alternative forms, specific embodiments are shown and described above by way of example in relation to the drawings, with a view to clearly explaining the various advantageous aspects of the present disclosure. It should be understood, however, that the detailed description herein and the drawings attached hereto are not intended to limit the disclosure to the particular form disclosed. Rather, the intention is to cover all modifications, equivalents, and alternatives falling within the scope of the following claims.

1. A terminal rivet (100) for a cylindrical secondary cell comprising:
a shaft (110) configured to extend axially (A) through a casing of the secondary cell to thereby electrically contact a current collecting plate of the secondary cell at a first end (110a) of the shaft (110); and
a head (120) arranged at a second end (110b) of the shaft (110), configured to form an external terminal for the cylindrical secondary cell;
wherein:
the head (120) comprises a central region (122) and a first welding region (124) arranged around said central region (122), wherein the first welding region (124) is recessed relative to said central region (122); and
the first end (110a) of the shaft (110) comprises a second welding region (114), aligned along the axis (A) of the shaft with the first welding region (124), and recessed towards the first welding region (124).

2. The terminal rivet according to claim 1, wherein:
the shaft is cylindrical and configured to extend axially through a circular opening in the casing of the cylindrical secondary cell; and
the head is substantially disc shaped, configured to close the circular opening in the casing of the cylindrical secondary cell.

3. The terminal rivet according to claim 1, wherein:
the first end of the shaft comprises a central region and the second welding region is arranged around said central region of the first end of the shaft.

4. The terminal rivet according to claim 1, wherein:
the second welding region corresponds in its shape to the first welding region.

5. The terminal rivet according to claim 1, wherein:
the first welding region is a continuous region surrounding the central region.

6. The terminal rivet according to claim 5, wherein:
the central region is circular and the first welding region is annular and concentric with the central region.

7. The terminal rivet according to claim 1, wherein:
the head further comprises a peripheral region arranged around the first welding region, and
the first welding region is recessed relative to said peripheral region.

8. The terminal rivet according to claim 1, wherein:
the first welding region is configured to receive a cap for the terminal rivet.

9. The terminal rivet according to claim 1, wherein:
the first end of the shaft further comprises a riveting region (518a) arranged around the second welding region, configured to deform under riveting of the terminal rivet.

10. A cylindrical secondary cell, comprising:
an electrode roll housed in a cylindrical casing;
the terminal rivet according to any preceding claim, arranged at a first end of the cylindrical casing; and
a current collecting plate in direct electrical contact with the electrode roll, wherein the first end of the shaft of the terminal rivet is in direct electrical contact with the current collecting plate.

11. The cylindrical secondary cell according to claim 10, wherein:
the current collecting plate has a first side for direct electrical contact with the terminal rivet, and a second side for direct electrical contact with the electrode roll; and
the first side of the current collecting plate comprises a protrusion configured to extend into the recessed second welding region on the first end of the shaft of the terminal rivet.

12. The cylindrical secondary cell according to claim 10, wherein:
the second side of the current collecting plate comprises a recess.

13. The cylindrical secondary cell according to claim 10, further comprising:
a cap arranged in the first welding region, configured to present an electrical contact surface for the external terminal for the cylindrical secondary cell.

14. The cylindrical secondary cell according to claim 10, wherein:
the first end of the casing comprises a first electrical contact surface extending in a first plane, and
the head of the rivet comprises a second electrical contact surface, extending in a second plane axially spaced from the first plane.

15. A method of manufacturing the cylindrical secondary cell according to claim 10, comprising:
arranging the terminal rivet and the current collecting plate such that the first end of the shaft of the terminal rivet abuts the current collecting plate; and
directing a welding means at the first welding region to thereby weld the terminal rivet to the current collecting plate.
